(19) United States
(12) Patent Application Publication
(10) Pub. No.: US 2018/0123835 A1
(43) Pub. Date: May 3, 2018

(54) CHANNEL SOUNDING

(71) Applicant: Aruba Networks, Inc., Sunnyvale, CA (US)

(72) Inventors: Shahnawaz Siraj, Sunnyvale, CA (US); Sachin Ganu, San Jose, CA (US)

(21) Appl. No.: 15/336,645

(22) Filed: Oct. 27, 2016

(51) Int. Cl. H04L 25/02; H04W 24/08

(52) U.S. Cl. CPC H04L 25/0224; H04W 24/08

(57) ABSTRACT

Example implementations relate to channel sounding based on channel conditions. For example, an apparatus may comprise a processing resource to: detect a plurality of stations (STAs) in communication with an access point (AP); determine a number of active STAs among the plurality of STAs in communication with the AP; perform channel sounding between the AP and a respective active STA among the plurality of active STAs at a first sounding interval; determine a coherence time associated with a channel between the AP and the respective active STA among the plurality of active STAs; adjust the first sounding interval to a second sounding interval based, at least in part, on the number of active STAs and the coherence time; and perform channel sounding between the AP the respective active STA among the plurality of STAs at the second sounding interval.

### BACKGROUND

Beamforming may be employed to increase the reliability and/or range of a communication link between an access point and a station. Beamforming may include the use of channel sounding between a beamformer and beamformee.

### BRIEF DESCRIPTION OF THE DRAWINGS

FIG. 1 illustrates a diagram of an example of a wireless network consistent with the disclosure.

FIG. 2 illustrates a diagram of an example of channel sounding between a beamformer and a beamformee consistent with the disclosure.

FIG. 3 illustrates a diagram of an example of channel sounding consistent with the disclosure.

FIG. 4 illustrates a diagram of an example of channel consistent with the disclosure.

FIG. 5 illustrates an apparatus for channel sounding consistent with the disclosure.

FIG. 6A illustrates a system for channel sounding consistent with the disclosure.

FIG. 6B illustrates another system for channel sounding consistent with the disclosure.

FIG. 7 illustrates a flow diagram for an example method for channel sounding consistent with the disclosure.

FIG. 8 illustrates a diagram of an example of a non-transitory computer readable medium and processing resource for channel sounding consistent with the disclosure.

### DETAILED DESCRIPTION

Wireless networks may be deployed to provide various types of communication to multiple users through the air using electromagnetic waves. As a result, various types of communication may be provided to multiple users without cables, wires, or other physical electric conductors to couple devices in the wireless network. Examples of the various types of communication that may be provided by wireless networks include voice communication, data communication, multimedia services, etc.

An example of a wireless network is a wireless local area network (WLAN). WLANs may include multiple stations (STAs) and/or access points (APs) that may communicate over a plurality of wireless channels. As used herein, an AP is a networking hardware device that allows a wireless-compliant device (e.g., a STA) to connect to a network. As used herein, wireless local area network (WLAN) generally refers to a communications network that links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

An AP may provide connectivity with a network such as the internet to the STAs. As used herein, AP generally refers to receiving points for any known or convenient wireless technology which may later become known. Specifically, the term AP is not intended to be limited to Institute of Electrical and Electronics Engineers (IEEE) 802.11-based APs. APs generally function as an electronic device that is adapted to allow wireless devices to connect to a wired network via various communications standards. As used herein, a STA is a device that has the capability to use the Institute of Electrical and Electronics Engineers (IEEE) 802.11 protocol. Examples of STAs include smart phones, laptops, physical non-virtualized computing devices, personal digital assistants, etc. In some examples, a STA may be a device that contains an IEEE 802.11-conformant media access control (MAC) and physical layer (PHY) interface to a wireless medium (WM).

Wireless networks such as WLANs can use one or more wireless communication technologies, for example, orthogonal frequency division multiplexing (OFDM). In an OFDM based wireless network, a data stream is split into multiple data substreams. Such data substreams may be sent over different OFDM subcarriers, which can be referred to as tones or frequency tones. Some wireless networks may use a single-in-single-out (SISO) communication approach, where each STA and/or AP uses a single antenna. Other wireless networks may use a multiple-in-multiple-out (MIMO) communication approach, where a STA and/or AP uses multiple transmit antennas and multiple receive antennas. WLANs such as those defined in the IEEE wireless communications standards, e.g., IEEE 802.11a, IEEE 802.11n, IEEE 802.11ac, etc. can use OFDM to transmit and receive signals. Moreover, WLANs, such as those based on the IEEE 802.11n or IEEE 802.11ac standards, can use OFDM and MIMO.

Beamforming (e.g., explicit transmit beamforming) may be used to increase the reliability and/or range of communication (e.g., a communication link) between an AP and a STA. In some examples, beamforming may include performing channel sounding between a beamformer and a beamformee. A beamformer may be a transmitter (Tx), and a beamformee may be a receiver (Rx). For example, a beamformer may be an AP, and a STA may be a beamformee.

Channel sounding may be performed on channel paths between APs and/or STAs to determine characteristics of a wireless environment in which the APs and/or STAs are deployed. In some approaches, characteristics determined from channel sounding may be calculated and/or reported on a per OFDM subcarrier basis. As used herein, “channel sounding” is a technique that may be used to determine and/or evaluate characteristics of a wireless network. For example, multidimensional spatial-temporal signals may propagate between APs and/or STAs in the wireless environment. Channel sounding may include processing of these multidimensional spatial-temporal signals to estimate and/or evaluate characteristics of the wireless network. In some approaches, these estimated and/or evaluated characteristics may be used to reduce effects of multipath wave propagation in a wireless network.

Channel sounding may be used to recalibrate a beamformer to use altered transmission weights for pre-coding of transmissions to a beamformee. The altered transmission weights may be compatible with conditions associated with a channel between the beamformer and the beamformee. In some examples, if a channel condition between the beamformer and the beamformee are quasi-static (e.g., when a coherence time associated with the channel is greater than a coherence time threshold), a channel sounding interval may be altered.

Beamforming may allow for an increase in a modulation coding scheme (MCS) index value. In some examples, beamforming may allow for an increase of 1 MCS index value. This increase may correspond to an increase in physical layer (PHY) rates. For example, an increase of 1 MCS index value may correspond to a 10-15% increase in PHY transmission rates. Accordingly, as the number of STAs associated with an AP increases, overhead associated with channel sounding may become greater than increases associated with channel sounding. Further, as the number of APs and/or STAs associated with a particular wireless network increases, interference between the APs and/or STAs may also increase.

In some approaches, beamforming and/or channel sounding may be performed within a static time interval. For example, a specified amount of time may be allocated for performing beamforming and/or channel sounding. In some approaches, this time interval may remain constant regardless of channel conditions between a beamformer and a beamformee. This time interval may be referred to herein as a “beamforming interval” or a “channel sounding interval” depending on whether beamforming or channel sounding is being referenced.

In contrast, examples herein may allow for dynamic beamforming and/or channel sounding. In some examples, dynamic beamforming and/or channel sounding may be based on a load and/or channel traffic associated with an AP or STA. For example, a beamforming interval and/or channel sounding interval may be altered based on load and/or channel traffic associated with an AP or STA.

Examples of the present disclosure include methods, apparatuses, and machine-readable media storing executable instructions for channel sounding. For example, methods, systems, and machine-readable media storing executable instructions that may allow for channel sounding between APs and STAs in a wireless network. In some examples, an apparatus may include a processing resource to execute instructions to detect a plurality of stations (STAs) in communication with an access point (AP) and determine a number of active STAs among the plurality of STAs in communication with the AP. The processing resource may execute instructions to perform channel sounding between the AP and a respective active STA among the plurality of STAs at a first sounding interval. In some examples, the processing resource may execute instructions to further determine a coherence time associated with a channel between the AP and the respective active STA among the plurality of active STAs, adjust the first sounding interval to a second sounding interval based, at least in part, on the number of active STAs and the coherence time, and perform channel sounding between the AP and the respective active STA among the plurality of active STAs at the second sounding interval.

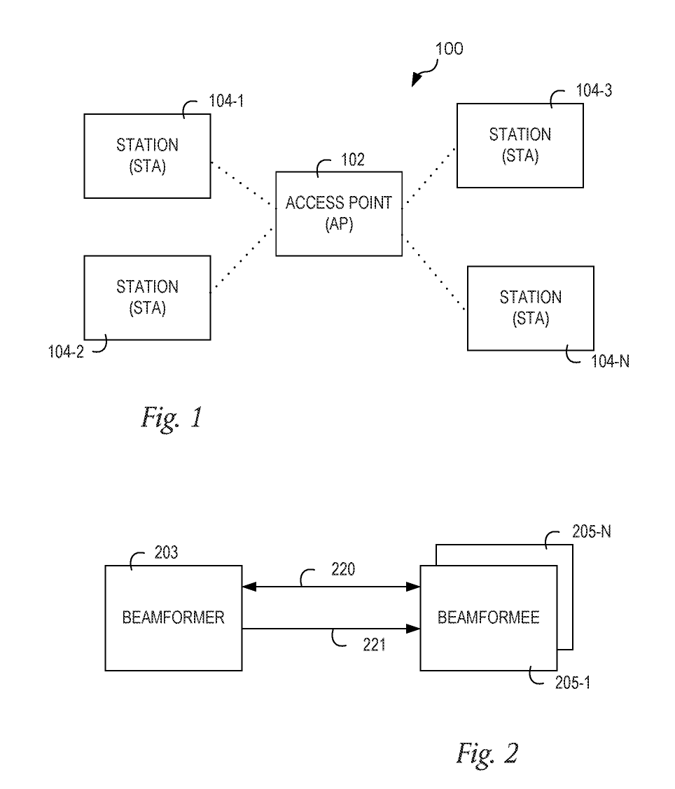

Turning now to the figures, FIG. 1 illustrates a diagram of an example of a wireless network 100 consistent with the disclosure. Wireless network 100 may include an access point (AP) 102 and a plurality of stations (STAs) 104-1, 104-2, 104-3, . . . , 104-N (referred to generally herein as STAs 104). As indicated by the dotted lines between the AP 102 and the STAs 104, the AP 102 can provide wireless connectivity to STAs 104 in the wireless network 100. In some examples, wireless connectivity may be provided between the AP 102 and the STAs 104 using spread-spectrum or orthogonal frequency-division multiplexing (OFDM) techniques.

FIG. 2 illustrates a diagram of an example of channel sounding between a beamformer 203 and beamformee 205 consistent with the disclosure. The beamformer 203 may be a device capable of shaping frames transmitted therefrom, and the beamformees 205-1, . . . , 205-N (referred to generally herein as beamformees 205) may be devices that receive frames transmitted from the beamformer 203. For example, the beamformer 203 may include a transmitter (Tx), and the beamformees 205 may include a receiver (Rx). In some examples, beamformer 203 may be an AP (e.g., AP 102 illustrated in FIG. 1), and beamformees 205 may be STAs (e.g., STAs 104 illustrated in FIG. 1).

As illustrated in FIG. 2, channel sounding 220 may be performed between the beamformer 203 and the beamformee(s) 205. Channel sounding 220 may include transmitting training sequences and receiving beamforming feedback that includes information regarding how the training sequences were heard at the beamformee(s) 205. For example, channel sounding 220 may include transmitting a null data packet announcement (NDPA) frame from the beamformer 203 to a beamformee 205. In some examples, the NDPA frame may be used to gain control of a channel between the beamformer 203 and beamformee 205, and/or identify beamformees 205. As used herein, information is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format such as a plurality of packets, frames, or cells.

As part of the channel sounding 220 process, in some examples, the beamformer 203 may transmit a null data packet (NDP) after transmitting the NDPA frame. The beamformee 205 may analyze training fields associated with a training sequences in the received NDP, and may determine a feedback matrix. In some examples, the beamformee 205 may analyze OFDM training fields to determine a response associated with the channel. In the case of multi-user transmissions, multiple NPDs may be transmitted.

In some examples, beamformees 205 can transmit the feedback matrix to beamformer 203. Using the feedback matrix, beamformer 203 can generate a steering matrix that may be used to direct a beamformed transmission 221 to the beamformee 205. For example, the beamformed transmission 221 may include frames that are biased along a particular direction or path, thereby increasing the reliability and/or range of transmission between the beamformer 203 and the beamformees 205.

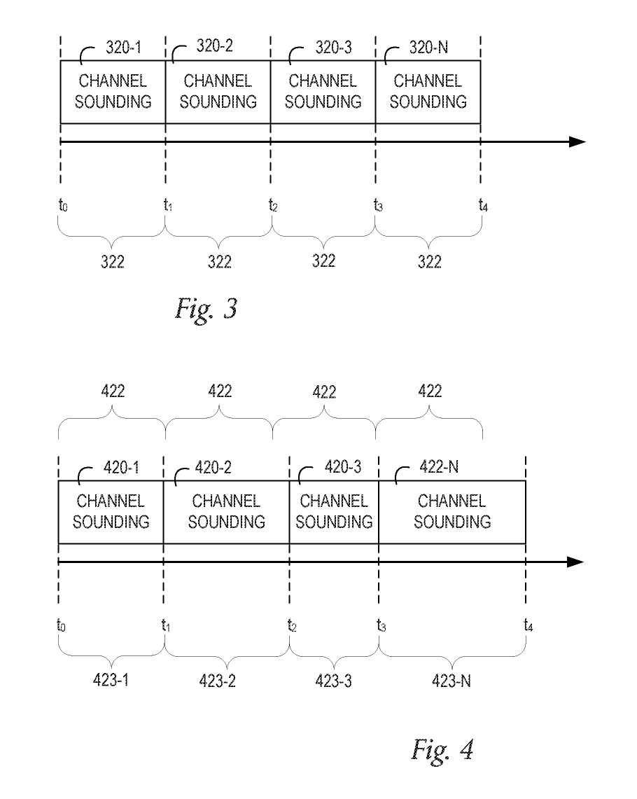

FIG. 3 illustrates a diagram of an example of channel sounding based on channel conditions consistent with the disclosure. In some approaches, as illustrated in FIG. 3, channel sounding 320-1, . . . , 320-N may be performed periodically. For example, channel sounding 320-1 may be performed for with a channel sounding interval 322 from time t₀ to time t₁. After channel sounding 320-1 is performed, channel sounding 320-2 may be performed with a channel sounding interval 322 from time t₁ to time t₂. Subsequently, channel sounding 320-3 may be performed with a channel sounding interval 322 from time t₂ to t₃. This may continue until channel sounding 320-N is performed with a channel sounding interval 322 from time t₃ to t₄.

As illustrated in FIG. 3, channel sounding interval 322 may be static. For example, the channel sounding interval 322 may be provided for a fixed amount of time. In some approaches, the channel sounding interval 322 may be around 100 milliseconds (ms).

In some approaches, a wireless network may include a single AP with a single associated STA. For the STA, the number of bytes for a beamforming operation may be determined based on the number of bytes associated with the NDPA, the NDP, and beamforming (BF). In this example, the NPDA may contain 104 bytes, the NDP may contain 85 btyes, and the BF may contain 914 bytes. Assuming an 80 MHz channel between the beamformer (e.g., beamformer 203 illustrated in FIG. 2) and a beamformee (e.g., beamformee 205-1 illustrated in FIG. 2), 3 Tx chains, and 3 Rx chains, the number of bytes associated with this example beamforming operation is then 1103.

In some examples, these frames may be transmitted at a physical layer (PHY) rate of 6 Mbps. Therefore, in this example, the time spent transmitting the channel sounding frame sequence is approximately 1.4 ms. If a static channel sounding interval 322 of 100 ms is used, an overhead associated with performing the channel sounding operation is approximately 1.4%.

If the number of STAs is increased from a single STA to 20 STAs associated with the single AP, the AP may implement round robin scheduling between the 20 STAs, and may transmit 5 ms of data to each respective STA among the 20 STAs (100 ms available for 20 STAs=5 ms). For example, if the channel sounding interval 322 associated with the AP is 100 ms and there are 20 STAs, the AP may continuously perform channel sounding 320 for 5 ms to each respective STA. In this example, if the AP spends 1.4 ms performing channel sounding 320 for 5 ms of data, the overhead associated with performing channel sounding 320 is approximately 28%.

FIG. 4 illustrates a diagram of an example of channel sounding based on channel conditions consistent with the disclosure. In contrast to the static channel sounding interval 322 illustrated in FIG. 3, FIG. 4 illustrates channel sounding 420-1, . . . , 420-N (referred to generally herein as channel sounding 420) performed aperiodically. In FIG. 4, static channel sounding intervals 422 correspond to static channel sounding intervals 322 illustrated in FIG. 3, and are provided to contrast the aperiodic channel sounding intervals 423 illustrated in FIG. 4 from the static channel sounding intervals 322 illustrated in FIG. 3.

As illustrated in FIG. 4, channel sounding 420-1 may be performed using a first channel sounding interval 423-1 from time t₀ to t₁. Subsequently, channel sounding 420-2 may be performed using a second channel sounding interval 423-2, from time t₁ to t₂. Similarly, subsequent to channel sounding 420-2, channel sounding 420-3 may be performed using a third channel sounding interval 423-3 from time t₂ to t₃, and channel sounding 420-N may be performed using a fourth channel sounding interval 423-N from time t₃ to t₄. As shown in FIG. 4, channel sounding intervals 423-1, . . . , 423-N may be longer, shorter, or equal in duration to static time intervals 422.

In some examples, a time duration associated with the channel sounding intervals 423-1, . . . , 423-N may be determined based on a coherence time associated with a channel between the AP and the STAs. As used herein, a “coherence time” is the time over which a propagating wave may be considered coherent. For example, a coherence time may be a time interval in which the phase of the propagating wave is, on average, predictable. In some examples, coherence time may be determined using implicit measurements of data packets transmitted via channels between the AP and STAs. For example, implicit measurements of upstream data packets transmitted from the STAs to the AP may be used to determine coherence time.

In some examples, a time interval associated with the channel sounding intervals 423-1, . . . , 423-N may be determined based on the number of STAs associated with an AP. For example, the time interval associated with the sounding intervals 423-1, . . . , 423-N may be increased or decreased based on the number of STAs associated with an AP. In some examples, the time interval associated with the channel sounding intervals 423-1, . . . , 423-N may be increased in response to a determination that a number of STAs associated with the AP is greater than a threshold value.

In some examples, a time interval associated with the channel sounding intervals 423-1, . . . , 423-N may be determined based on a signal to noise ratio (SNR) associated with beamforming feedback. For example, the time interval associated with the channel sounding intervals 423-1, . . . , 423-N may be determined based on the average SNR per subcarrier received from the beamforming feedback received from the STAs.

For example, at each sounding interval, an average SNR received from beamforming feedback may be used to determine information regarding the condition of a channel between an AP and a STA. A change in the SNR between a previously received SNR and a current SNR may be determined. This may be repeated for each STA in a wireless network. The change in SNR may then be used to determine a number of STAs that have a SNR greater than or less than the change in SNR. In some examples, a channel sounding interval associated with the STAs having a SNR greater than the change in SNR may be altered in response.

In some examples, the time interval associated with the channel sounding intervals 423-1, . . . , 423-N may be determined based a fluctuation of transmission rates (e.g., PHY transmission rates) and/or a packer error rate (PER). For example, if the transmission rate drops below a threshold transmission rate, a channel sounding interval 423-1, . . . , 423-N may be altered (e.g., increased or decreased). In some examples, this may allow for an increase in channel estimation accuracy. Similarly, if the PER exceeds a threshold PER, a channel sounding interval |423-1, . . . , 423-N may be altered. In some examples, a channel sounding interval 423-1, . . . , 423-N may be altered in response to a determination that PHY transmission rate is stable and the PER is below a threshold PER.

As a non-limiting example, assuming an airtime allocation of 100 ms per STA and a beamforming overhead of 1.4% per STA, for beamforming overhead to be less than 10% of a transmit opportunity (TxOp) per STA, a channel sounding interval may be 280 ms. In contrast to the above example using static channel sounding interval 322 of 100 ms, a channel sounding interval of 280 ms may result in the overhead associated with performing channel sounding decreasing from 28% to 10% for 20 STAs associated with an AP.

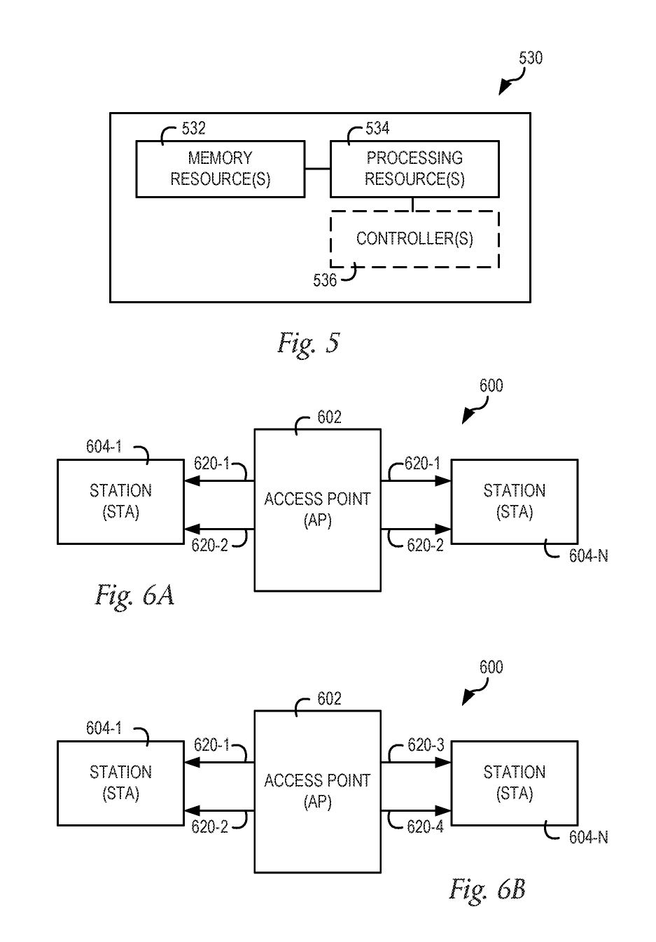

FIG. 5 illustrates an apparatus 530 for channel sounding based on channel conditions consistent with the disclosure. As shown in FIG. 5, the apparatus 530 may include a memory resource(s) 532, processing resource(s) 534, and, optionally, controller(s) 536. By way of example, the memory resource(s) 532 may include volatile and/or non-volatile memory, and the processing resource(s) 534 may include processors, microprocessors, etc. In some examples, the processing resource 534 may execute instructions. The instructions may be stored in a memory resource coupled to the processing resource 534 and/or the instructions may be stored on a non-transitory machine-readable medium.

In some examples, the processing resource(s) 532 and/or controller(s) 536 may detect a plurality of STAs in communication with an AP. For example, the processing resource(s) 532 and/or controller(s) 536 may determine that a plurality of STAs are associated with an AP. The processing resource(s) 532 and/or controller(s) 536 may determine a number of active STAs among the plurality of STAs in communication with the AP. For example, the processing resource(s) 532 and/or controller(s) 536 may determine how many active STAs are associated with the AP.

In some examples, the processing resource(s) 532 and/or controller(s) 536 may perform channel sounding between the AP and a respective active STA among the plurality of STAs at a first channel sounding interval. The processing resource(s) 532 and/or controller(s) 536 may further determine a coherence time associated with a channel between the AP and the respective active STA among the plurality of active STAs, as described in connection with FIG. 4, herein.

The processing resource(s) 532 and/or controller(s) 536 may adjust the first channel sounding interval to a second channel sounding interval based, at least in part, on the number of active STAs and the coherence time. In some examples, the processing resource(s) 532 and/or controller(s) 536 may then perform channel sounding between the AP and the respective STA among the plurality of STAs at the second channel sounding interval. In some examples, the second channel sounding interval may comprise a time interval that is longer in duration than a time interval associated with the first channel sounding interval.

In some examples, the processing resource(s) 532 and/or controller(s) 536 may determine a signal to noise ratio (SNR) associated with feedback associated with performing the channel sounding, and adjust the first sounding interval to the second sounding interval based, at least in part, on the SNR.

In some examples, the processing resource(s) 532 and/or controller(s) 536 may determine that a transmission rate (e.g., PHY transmission rate) associated with the channel between the AP and the respective active STA among the plurality of active STAs has decreased below a transmission rate threshold and adjust the first sounding interval to the second sounding interval based, at least in part on the determination that the transmission rate has decreased below the transmission rate threshold.

In some examples, the processing resource(s) 532 and/or controller(s) 536 may detect a packet error rate (PER) associated with the channel between the AP and the respective active STA among the plurality of active STAs has increased above a PER threshold and adjust the first sounding interval to the second sounding interval based, at least in part on detecting that the PER has increased above the PER threshold.

FIG. 6A illustrates a system for channel sounding based on channel conditions consistent with the disclosure. As shown in FIG. 6A, an AP 602 can be in communication with a plurality of STAs 604-1, . . . , 604-N. The AP may perform channel sounding 620-1 at a first channel sounding interval (e.g., channel sounding interval 423-1 illustrated in FIG. 4). Subsequently, in response to a determination that channel condition has changed, AP 602 may perform channel sounding 620-2 at a second channel sounding interval (e.g., channel sounding interval 423-2 illustrated in FIG. 4).

FIG. 6B illustrates another system for channel sounding intervals consistent with the disclosure. As shown in FIG. 6B, an AP 602 can be in communication with a plurality of STAs 604-1, . . . , 604-N. The AP 602 may perform channel sounding 620-1 with a first STA 604-1 at a first channel sounding interval (e.g., channel sounding interval 423-1 illustrated in FIG. 4). Subsequently, in response to a determination that channel condition has changed, AP 602 may perform channel sounding 620-2 at a second channel sounding interval (e.g., channel sounding interval 423-2 illustrated in FIG. 4).

In some examples, AP 602 may perform channel sounding 620-1, 620-2, 620-3, . . . , 620-4 using different channel sounding intervals for different STAs 604. For example, the AP 602 may perform channel sounding 620-3 with an N^{th} STA 604-N at a third channel sounding interval (e.g., channel sounding interval 423-3 illustrated in FIG. 4). Subsequently, in response to a determination that channel condition has changed, AP 602 may perform channel sounding 620-4 with N^{th} STA 604-N at a second channel sounding interval (e.g., channel sounding interval 423-4 illustrated in FIG. 4).

In some examples, the channel condition may change based on the number of STAs 604 associated with the AP 602. Examples are not so limited; however, and the channel condition may change based on a SNR received from beamforming feedback, a change in PHY transmission rates, and/or a change in the PER, among other channel conditions.

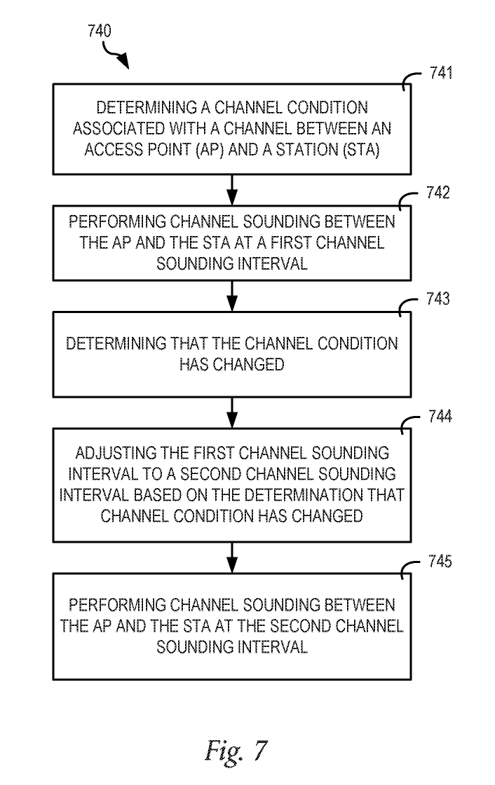

FIG. 7 illustrates a flow diagram for an example method 740 for channel sounding based on channel conditions consistent with the disclosure. At 741, the method 740 may include determining a channel condition associated with a channel between an access point (AP) and a station (STA).

At 742, the method 740 may include performing channel sounding between the AP and the STA at a first channel sounding interval. In some examples, the first channel sounding interval may be around 100 ms.

At 743, the method 740 may include determining that the channel condition has changed. In some examples, determining that the channel condition has changed may include determining that a coherence time associated with a channel between the AP and the STA has changed and determining that a signal to noise ratio (SNR) associated with the channel between the AP and the STA has changed.

At 744, the method 740 may include adjusting the first channel sounding interval to a second channel sounding interval based on the determination that the channel condition has changed. In some examples, adjusting the first channel sounding interval to the second channel sounding interval may include increasing a time interval associated with the first channel sounding interval such that the time interval associated with the second channel sounding interval is greater than the time interval associated with the first channel sounding interval.

At 745, the method 740 may include performing channel sounding between the AP and the STA at the second channel sounding interval. In some examples, the second sounding interval may be greater than or less than 100 ms. In some examples, the method 740 may include performing beamforming between the AP and the STA.

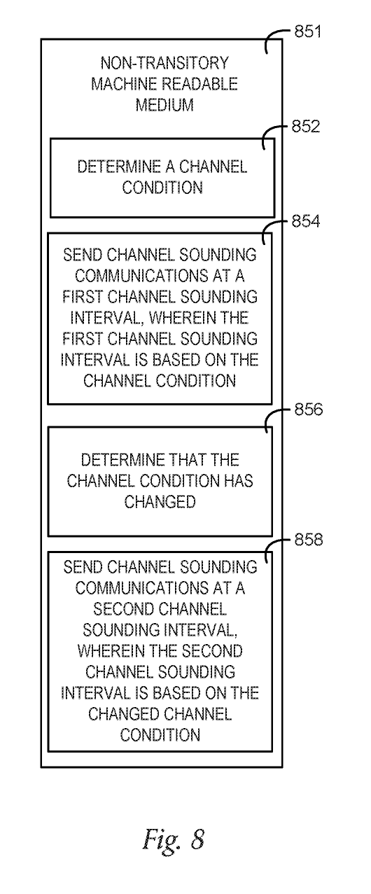

FIG. 8 illustrates a diagram of an example of a non-transitory machine readable medium 851 for channel sounding based on channel conditions consistent with the disclosure. A processing resource may execute instructions stored on the non-transitory machine readable medium 851. The non-transitory machine readable medium 851 may be any type of volatile or non-volatile memory or storage, such as random access memory (RAM), flash memory, read-only memory (ROM), storage volumes, a hard disk, or a combination thereof.

The example medium 851 may store instructions 852 executable by a processing resource to determine a channel condition. In some examples, the channel condition may include a number of STAs associated with an AP, a SNR received from beamforming feedback between the AP and an STA, a change in PHY transmission rates associated with a channel between the AP and STA, and/or a change in the PER associated with a channel between the AP and an STA, among other channel conditions.

In some examples, the example medium 851 may store instructions 854 executable by a processing resource to send channel sounding communications at a first channel sounding interval, wherein the first sounding interval is based on the channel condition.

In some examples, the example medium 851 may store instructions 856 executable by a processing resource to determine that the channel condition has changed. For example, instructions 856 may be executable to determine that a number of STAs associated with an AP has changed, that PHY transmission rates associated with a channel between the AP and STA, that a PER associated with a channel between the AP and an STA has changed, and/or that a SNR received from beamforming feedback between the AP and an STA has changed.

The example medium 851 may store instructions 858 executable by a processing resource to send channel sounding communications at a second channel sounding interval, wherein the second channel sounding interval is based on the changed channel condition.

In some examples, the example medium 851 may store instructions executable by a processing resource to send channel sounding communications via a channel between an access point (AP) and a station (STA) at the first channel sounding interval, and to send channel sounding communications via the channel between the AP and the STA at the second channel sounding interval. In some examples, the channel condition may comprise a number of stations (STAs) associated with an access point (AP). In some examples, the channel condition may comprise a coherence time associated with a channel between an access point (AP) a station (STA) associated with the AP.

The example medium 851 may store instructions executable by a processing resource to determine the channel condition based on a change in a packet error rate associated with a channel between an access point (AP) a station (STA) associated with the AP.

In some examples, the example medium 851 may store instructions executable by a processing resource to determine the channel condition based on a change in a transmission rate associated with a channel between an access point (AP) a station (STA) associated with the AP.

In the foregoing detailed description of the present disclosure, reference is made to the accompanying drawings that form a part hereof, and in which is shown by way of illustration how one or more examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. As used herein, designators such as “N”, etc., particularly with respect to reference numerals in the drawings, indicate that a number of the particular feature so designated can be included. As used herein, “a number of” a particular thing can refer to one or more of such things (e.g., a number of computing devices can refer to one or more computing devices). A “plurality of” is intended to refer to more than one of such things. Multiple like elements may be referenced herein generally by their reference numeral without a specific identifier at the end. For example, a plurality of STAs 104-1, . . . , 104-N may be referred to herein generally as STAs 104.

The figures herein follow a numbering convention in which the first digit corresponds to the drawing figure number and the remaining digits identify an element or component in the drawing. For example, reference numeral 220 may refer to element “20” in FIG. 2 and an analogous element may be identified by reference numeral 320 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

As used herein, “logic” is an alternative or additional processing resource to perform a particular action and/or function, etc., described herein, which includes hardware, for example, various forms of transistor logic, application specific integrated circuits (ASICs), etc., as opposed to computer executable instructions, for example, instructions, etc., stored in memory and executable by a processor.

What is claimed:

1. A non-transitory machine-readable medium storing instructions executable by a processing resource to:
determine a channel condition;
send channel sounding communications at a first channel sounding interval, wherein the first sounding interval is based on the channel condition;
determine that the channel condition has changed; and
send channel sounding communications at a second channel sounding interval, wherein the second channel sounding interval is based on the changed channel condition.

2. The non-transitory machine-readable medium of claim 1, wherein the instructions are executable by the processing resource to:
send channel sounding communications via a channel between an access point (AP) and a station (STA) at the first channel sounding interval; and
send channel sounding communications via the channel between the AP and the STA at the second channel sounding interval.

3. The non-transitory machine-readable medium of claim 1, wherein the channel condition comprises a number of stations (STAs) associated with an access point (AP).

4. The non-transitory machine-readable medium of claim 1, wherein the channel condition comprises a coherence time associated with a channel between an access point (AP) a station (STA) associated with the AP.

5. The non-transitory machine-readable medium of claim 1, wherein the instructions are executable by the processing resource to determine the channel condition based on a change in a packet error rate associated with a channel between an access point (AP) a station (STA) associated with the AP.

6. The non-transitory machine-readable medium of claim 1, wherein the instructions are executable by the processing resource to determine the channel condition based on a change in a transmission rate associated with a channel between an access point (AP) a station (STA) associated with the AP.

7. An apparatus, comprising a processing resource to execute instructions to:
detect a plurality of stations (STAs) in communication with an access point (AP);
determine a number of active STAs among the plurality of STAs in communication with the AP;
perform channel sounding between the AP and a respective active STA among the plurality of STAs at a first channel sounding interval;
determine a coherence time associated with a channel between the AP and the respective active STA among the plurality of active STAs;
adjust the first channel sounding interval to a second channel sounding interval based, at least in part, on the number of active STAs and the coherence time; and
perform channel sounding between the AP and the respective active STA among the plurality of active STAs at the second channel sounding interval.

8. The apparatus of claim 7, wherein the processing resource is to:
determine a signal to noise ratio (SNR) associated with feedback associated with performing the channel sounding; and
adjust the first sounding interval to the second sounding interval based, at least in part, on the SNR.

9. The apparatus of claim 7, wherein the second channel sounding interval comprises a time interval that is longer in duration than a time interval associated with the first channel sounding interval.

10. The apparatus of claim 7, wherein the processing resource is to:
determine that a transmission rate associated with the channel between the AP and the respective active STA among the plurality of active STAs has decreased below a transmission rate threshold; and
adjust the first sounding interval to the second sounding interval based, at least in part on the determination that the transmission rate has decreased below the transmission rate threshold.

11. The apparatus of claim 7, wherein the processing resource is to:
detect a packet error rate (PER) associated with the channel between the AP and the respective active STA among the plurality of active STAs has increased above a PER threshold; and
adjust the first sounding interval to the second sounding interval based, at least in part on detecting that the PER has increased above the PER threshold.

12. A method, comprising:
determining a channel condition associated with a channel between an access point (AP) and a station (STA);
performing channel sounding between the AP and the STA at a first channel sounding interval;
determining that the channel condition has changed;
adjusting the first channel sounding interval to a second channel sounding interval based on the determination that the channel condition has changed; and
performing channel sounding between the AP and the STA at the second channel sounding interval.

13. The method of claim 12, wherein determining that the channel condition has changed comprises:
determining that a coherence time associated with a channel between the AP and the STA has changed; and
determining that a signal to noise ratio (SNR) associated with the channel between the AP and the STA has changed.

14. The method of claim 13, wherein adjusting the first channel sounding interval to the second channel sounding interval comprises increasing a time interval associated with the first channel sounding interval such that the time interval associated with the second channel sounding interval is greater than the time interval associated with the first channel sounding interval.

15. The method of claim 13, further comprising performing beamforming between the AP and the STA.
